(19) United States
(12) Patent Application Publication
(10) Pub. No.: US 2002/0104032 A1
(43) Pub. Date: Aug. 1, 2002

(54) Method for reducing power consumption using variable frequency clocks

(76) Inventors: Mazin Khurshid, San Jose, CA (US); Duen-Shun Wen, (US)

Correspondence Address: J.C. Patents, Inc., 4 Venture, Suite 250, Irvine, CA, 92618, US

(21) Appl. No.: 09/772,817

(22) Filed: Jan. 30, 2001

(51) Int. Cl. G06F 1/26; G06F 1/28; G06F 1/30

(52) U.S. Cl. 713/322

(57) ABSTRACT

The present invention provides a method of extending the processor core clock based on feedback provided by application requirements in order to reduce power consumption. Power saving in a processor can be achieved by using the following methods of stopping the clock. Method of achieving this are by stopping the clock of the processor under software control, stopping or gating the clock of certain units that are not being used, extending the clock of the processor based on a combination of software and the type of instruction being executed. extending the clock of certain functional units or certain areas of the processor instead of stalling the processor, stalling the clock when the processor needs to be stalled and restarted when the stall condition is about to end, extending the clock so that instructions can be executed at a slower frequency, implementing a combination of the before-described schemes. The clock input to functional units or certain areas of the chip is controlled by three different sources, and can be extended or stopped depending on the requirements. The first source is the hardware stall mechanism, which is completely hardware based. The second source is software shutdown logic. The third source is software/hardware extend logic which extends the clock by variable amounts depending on the application load factor and the enable signal.

### BACKGROUND OF THE INVENTION

1. Field of Invention

The present invention relates to power savings, and more particularly, to a method of saving power by extending the processor core clock.

2. Description of Related Art

Power consumption is a major system concern, especially for, but not limited to, portable systems which are powered by battery. With a battery-powered portable system, it is advantageous to be able to save power in order to extend battery life.

A conventional approach to reducing power consumption is by reducing the processor's voltage level. This is due to the fact that power consumption is approximately proportional to the square of the supply voltage level.

Another conventional approach is to manipulate the clock frequency. Generally, lowering the clock frequency of a device results in a reduction in the power consumption of the device.

However, there are certain problems associated with the conventional approaches to reducing power consumption. Chief among the disadvantages is the increased resource overhead that is required to perform the desired power consumption reduction. This overhead in resources often actually causes the overall system power consumption to actually increase instead of decrease.

### SUMMARY OF THE INVENTION

The present invention provides a method of extending the processor core clock based on feedback provided by application requirements.

Power saving in a processor can be achieved by using the following methods of stopping the clock. One method is achieved by stopping the clock of the processor under software control, e.g. power-down modes and standby modes. The second method is by stopping or gating the clock of certain units that are not being used.

In the above methods the processor or individual functional units are stopped or idle. Additional power savings can be obtained when the processor or its functional units are executing instructions. This is done by extending the clock of the processor based on a combination of software and the type of instruction being executed. Processor instruction set consists of various types of instructions, some of which can be executed in a single cycle and some require multiple cycles. For these multiple cycle instructions the processor usually stalls the pipeline for multiple clocks.

The same functionality can be obtained by extending the clock of certain functional units or certain areas of the processor instead of stalling the processor. The clock can be stopped when the processor needs to be stalled and restarted when the stall condition is about to end. This prevents power dissipation during the stall cycles of the processor.

The above scheme work for instructions which require multiple cycles. Single cycle instructions are usually designed for performance intensive tasks, but certain applications use single cycle instructions but performance is not critical. For example, dialing the number in a cellular phone compared to Internet access on a cellular phone, the dialing process will use single cycle instructions, but the performance requirement is low. Thus, the sequence of these instructions can be executed at a slower frequency by extending or running the clock at a slower frequency under software control depending on the application level.

Another method entails implementing a combination of the above-described schemes. The clock input to functional units or certain areas of the chip is controlled by three different sources, and can be extended or stopped depending on the requirements. The first source is the hardware stall mechanism, which is completely hardware based. The second source is software shutdown logic. The third source is software/hardware extend logic which extends the clock by different amounts depending on the application load factor and the enable signal.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a timing diagram for a processor stall for multi clock instructions according to an embodiment of the present invention;

FIG. 2 shows a timing diagram for a processor stall based on clock extension according to an embodiment of the present invention;

FIG. 3 shows a timing diagram for execution of single cycle instructions at variable frequencies according to an embodiment of the present invention; and

FIG. 4 shows circuit block diagram of a method for implementing clock extensions for various blocks according to an embodiment of the present invention.

### DESCRIPTION OF THE PREFERRED EMBODIMENTS

In order to overcome the shortcomings and disadvantages of the conventional design, the present invention provides a method for reducing power consumption by utilizing variable clock frequencies controlled by application load.

Power saving in a processor can be achieved by using the following methods of stopping the clock. One method is achieved by stopping the clock of the processor under software control, e.g. power-down modes and standby modes. The second method is by stopping or gating the clock of certain units that are not being used.

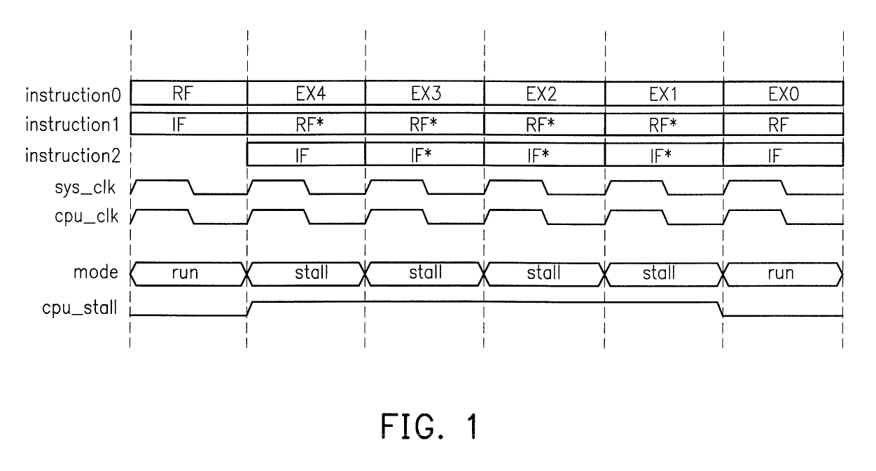

In the above methods the processor or individual functional units are stopped or idle. Additional power savings can be obtained when the processor or its functional units are executing instructions. This is done by extending the clock of the processor based on a combination of software and the type of instruction being executed. Processor instruction set consists of various types of instructions, some of which can be executed in a single cycle and some require multiple cycles. For these multiple cycle instructions, the processor usually stalls the pipeline for multiple clocks as shown in FIG. 1.

Referring to FIG. 1 which shows a timing diagram for a processor stall for multiple clock cycle instructions according to an embodiment of the present invention. In the first clock cycle the processor is in run mode. Both sys_clk and cpu_clk are running at their standard operating frequency.

In the second clock cycle the cpu_stall signal makes a transition to an active level. This then causes the mode to switch from run mode to stall mode. The sys_clk and cpu_clk continue running at their standard operating frequency.

In the sixth clock cycle the cpu_stall signal makes a transition to an inactive level. This in turn causes the mode to switch from stall mode back into run mode.

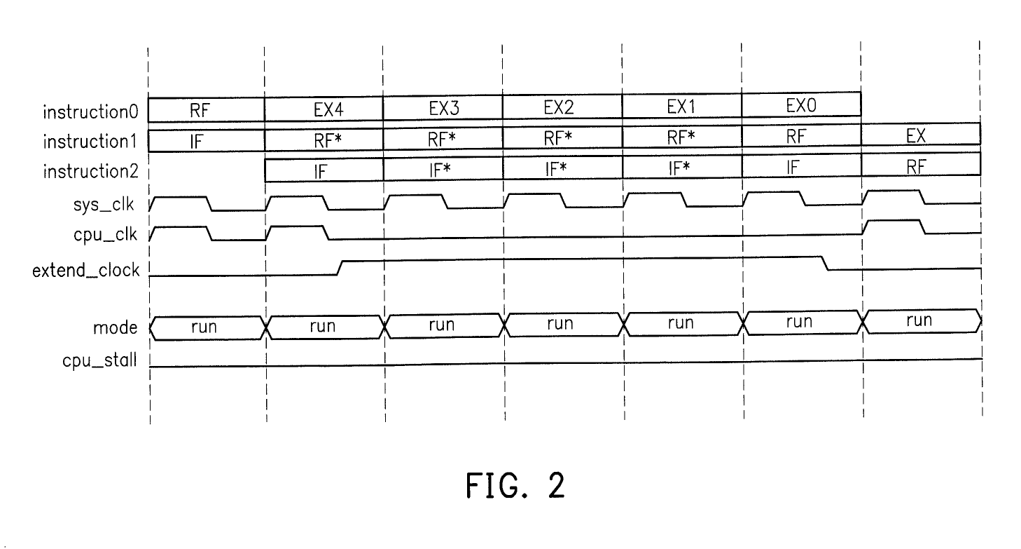

The same functionality can be obtained by extending the clock of certain functional units or certain areas of the processor instead of stalling the processor. The clock can be stopped when the processor needs to be stalled and restarted when the stall condition is about to end. This prevents power dissipation during the stall cycles of the processor. This is illustrated in FIG. 2 which shows a timing diagram for a processor stall based on clock extension according to an embodiment of the present invention.

Referring to FIG. 2. Clock cycle 1 of FIG. 2 is the same as clock cycle 1 of FIG. 1 except for the additional extend_clock signal which is low or inactive. Both sys_clk and cpu_clk are running at their standard operating frequencies. The extend_clock signal is in an inactive or low state.

During the latter half of clock cycle 2, the extend_clock goes active or high. While the extend_clock signal is at an active level, the cpu_clk signal will not make an active transition. The sys_clk signal is not affected and continues running at the standard operating frequency. The cpu_clk signal remains in an inactive low state through clock cycle 6, during the latter half of which the extend_clock signal goes low or inactive. In clock cycle 7, cpu_clk returns to running at the standard operating frequency.

Note that the cpu_stall signal remains at an inactive low level and the mode does not change but stays in run mode.

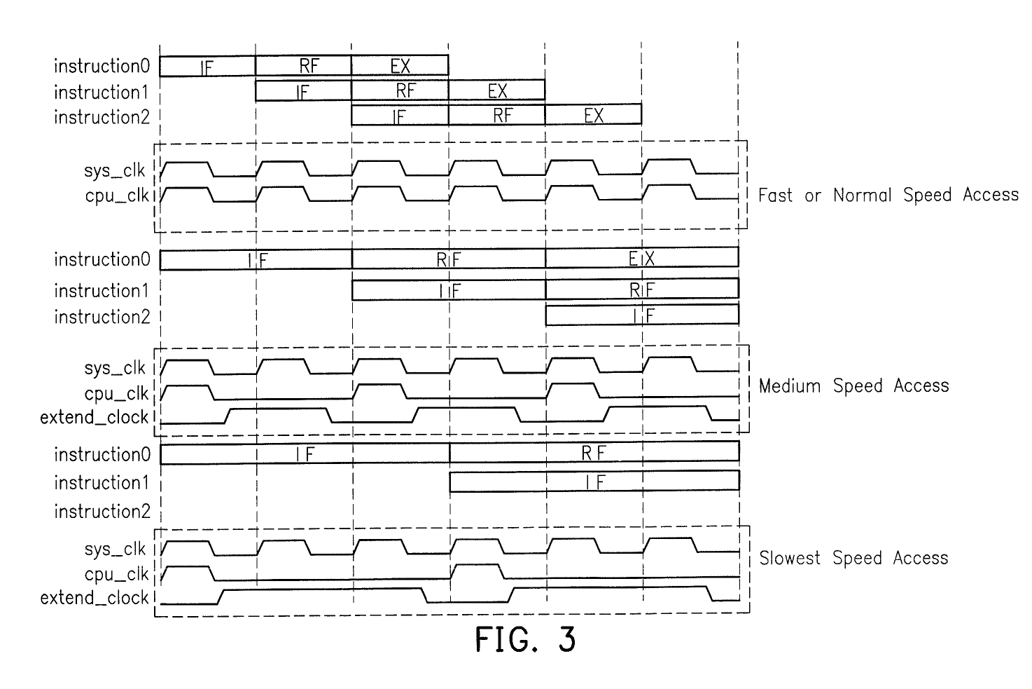

The above schemes work for instructions which require multiple cycles. Single cycle instructions are usually designed for performance intensive tasks, but certain applications use single cycle instructions even when performance is not critical. For example, dialing the number in a cellular phone compared to Internet access on a cellular phone. The dialing process will use single cycle instructions, but the performance requirement is low. Thus, the sequence of these instructions can be executed at a slower frequency by extending or running the clock at a slower frequency under software control depending on the application level. FIG. 3 shows a timing diagram for such cases for execution of single cycle instructions at variable frequencies according to an embodiment of the present invention.

Referring to FIG. 3. The timing diagram is divided into three sections which are separated by access speed. The first section at the top of the timing diagram is for fast or normal speed access. The second section in the middle of the timing diagram is for medium speed access. The third section at the bottom of the timing diagram is for slow speed access. In the first section for fast or normal speed access, both the sys_clk and cpu_clk signals continue running at their standard operating frequency for the duration of the top section. In the top section each instruction is one clock cycle in duration.

In the second section for medium speed access, the sys_clk signal continues running at the standard operating frequency. However, the frequency of the cpu_clk is now lower. This is due to the extend_clock signal going active during the Iatter part of clock cycle 1. While extend clock is active or high, the cpu_clk will not make a transition in state. Therefore, cpu_clk remains low until extend clock goes inactive or low. When extend clock does go low towards the end of clock cycle 2, cpu_clk resumes operation with an active high transition at the beginning of clock cycle 3. In this example, the extend clock causes the cpu_clk signal frequency to be cut in approximately half. Therefore, the instruction length is doubled. This can be seen by comparing instruction 0, instruction 1, and instruction 2 of the top section with instruction 0, instruction 1, and instruction 2 of the middle section. The length of IF of instruction 0 in the middle section is twice the length of IF of instruction 0 in the top section. The same is true for instruction 1 and instruction 2.

In the third section for slow speed access, the sys_clk signal continues running at the standard operating frequency. The cpu_clk signal is affected in the same way as with the medium speed access. Therefore, since the extend clock signal stays active even longer than in the medium speed access, the cpu_clk signal frequency is lower.

Comparing instruction 0, instruction 1, and instruction 2 in the fast or normal speed access with the same signals in the medium and slow speed access timing diagram, the relationship between the frequency of the cpu_clk signal and the length of the instruction signals can be seen.

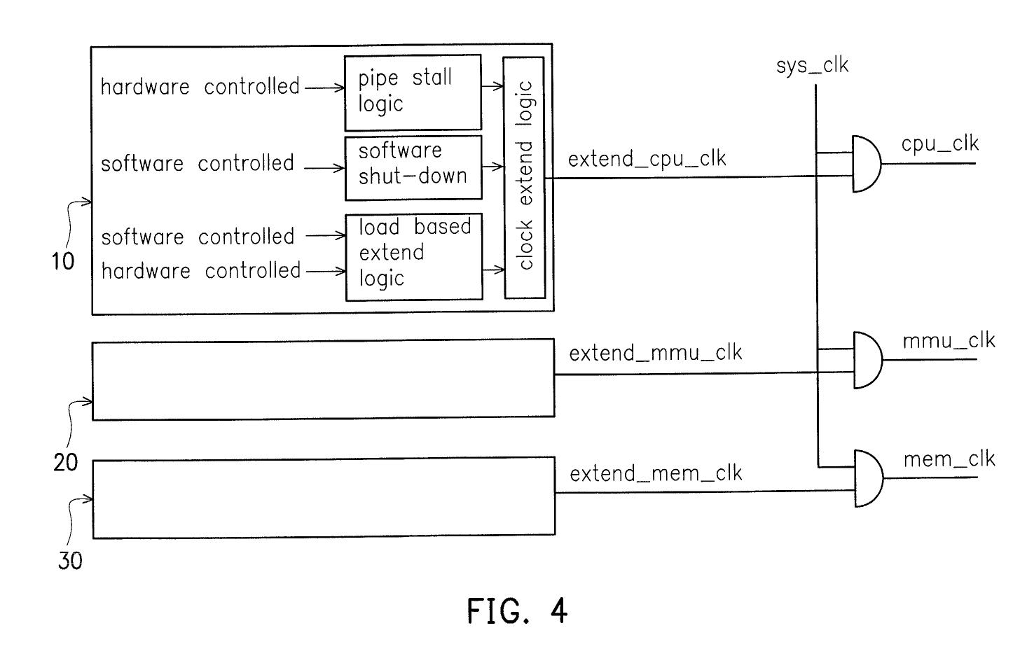

FIG. 4 shows a circuit block diagram of a method for obtaining power savings based on variable clock frequencies according to an embodiment of the present invention. The clock input to functional units or certain areas of the chip is controlled by three different sources, and can be extended or stopped depending on the requirements. The first source is the hardware stall mechanism, which is completely hardware based. The second source is software shutdown logic. The third source is software/hardware extend logic which extends the clock by different amounts depending on the application load factor and the enable signal.

In the extend cpu clock block 10, if the pipeline is stalled by hardware control, if the clock of the processor is stopped or shutdown by software control, or if the clock is extended by software or hardware control based on application load, the clock extend logic will generate an appropriate extend_cpu_clk signal.

There are also similar logic controls in the extend mmu clock block 20 and the extend mem clock block 30 which generate appropriate extend_mmu_clk and extend_mem_clk signals respectively.

The sys_clk signal works as an output enable for the extend cpu_clk, extend_mmu_clk, and extend_mem_clk signals as sys_clk is logically anded to each of the three extend clk signals individually. Without the sys_clk signal, the signals cpu_clk, mmu_clk, and mem_clk will not make transitions.

Using the methods of the present invention, the clocking signal frequencies supplied to various devices or components can be controlled by hardware and software. As devices consume power at a rate proportional to the frequency of the clocking signal, power consumption can be effectively reduced by extending or varying clock frequencies.

Therefore, a versatile and effective method for reducing power consumption by varying frequencies according to application load is achieved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of reducing power consumption by varying clock frequencies comprising:
detecting a hardware controlled pipeline stall;
detecting a software controlled shutdown;
detecting a software or hardware controlled load based extended clock cycle; and
generating an extended clock signal based upon detection of the hardware controlled pipeline stall, the software controlled shutdown, or the software or hardware controlled load based extended clock cycle.

2. The method of claim 1, wherein the generated extended clock signal is logically anded to a system clock.

3. The method of claim 2, wherein the generated extended clock signal is a processor clock signal.

4. The method of claim 2, wherein the generated extended clock signal is a memory clock signal.

5. The method of claim 2, wherein the generated extended clock signal is an memory management unit clock signal.

6. A method of reducing power consumption by varying clock frequencies comprising:
detecting a hardware controlled pipeline stall;
detecting a software controlled shutdown;
detecting a software or hardware controlled load based extended clock cycle; and
generating a stalled clock signal based upon detection of the hardware controlled pipeline stall, the software controlled shutdown, or the software or hardware controlled load based extended clock cycle.

7. The method of claim 1, wherein the generated stalled clock signal is logically anded to a system clock.

8. The method of claim 2, wherein the generated stalled clock signal is a processor clock signal.

9. The method of claim 2, wherein the generated stalled clock signal is a memory clock signal.

10. The method of claim 2, wherein the generated stalled clock signal is an memory management unit clock signal.

11. A method of reducing power consumption by varying clock frequencies comprising:
generating an extended clock signal based upon a hardware controlled pipeline stall, a software controlled shutdown, or a software or hardware controlled load based extended clock cycle.

12. A method of reducing power consumption by varying clock frequencies comprising:
generating a stalled clock signal based upon a hardware controlled pipeline stall, a software controlled shutdown, or a software or hardware controlled load based extended clock cycle.

13. A method of reducing power consumption by varying clock frequencies comprising:
extending a processor clock signal based on a combination of software and an instruction type being executed.

14. The method of claim 13 wherein the instruction type is a multiple clock cycle instruction.

15. The method of claim 14 wherein the processor clock signal is stalled for multiple clock cycles.

16. A method of reducing power consumption by varying clock frequencies comprising:
stalling a system clock signal when a processor is going to enter a stall condition and restarting the system clock signal when the processor is going to exit the stall condition.

17. A method of reducing power consumption by varying clock frequencies comprising:
extending a clock signal to a slower frequency under software control depending on application load.
